(19) United States
(12) Patent Application Publication
(10) Pub. No.: US 2007/0143293 A1
(43) Pub. Date: Jun. 21, 2007

(54) Portable device and network information browsing system and method

(75) Inventor: Kah-Jing Suen, Taipei City (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/300,326

(22) Filed: Dec. 15, 2005

(51) Int. Cl. G06F 17/30

(52) U.S. Cl. 707/10

(57) ABSTRACT

A network information browsing system includes a host and a portable device, which includes a transmitting module, a database, an interface module, a selecting module, and a re-searching module. In this case, the host retrieves a plurality of data through network. The transmitting module connects to the host for receiving the data. The interface module displays at least one of the data, and the selecting module generates at least one keyword based on the displayed data. The re-searching module automatically performs a data searching action according to the keyword.

### BACKGROUND OF THE INVENTION

1. Field of Invention

The invention relates to network information browsing system and method and, in particular, to network information browsing system and method suitable for a portable device to off-line browse.

2. Related Art

Recently, the Internet industry is progressively developed. Accordingly, to search through the network has become one of the most popular information resources.

As shown in FIG. 1, in a conventional network browsing system 1, a user 20 utilizes a host 10 to connect to Internet 30. In general, the user 20 firstly inputs the keyword(s) to the host 10, and then the host 10 can search the data 31 matching the keyword(s) from the Internet 30 with utilizing the searching engine(s). After that, the searched data 31 are downloaded to the host 10, so that the user 20 can accordingly use the browser the view the data 31.

Recently, many users have many chances to travel on official business for the demands of global businesses. Thus, the conventional heavy host, such as the desktop computer, cannot match the requirements of movement for the users. Accordingly, those skilled persons developed various kinds of portable electronic devices such as the PDA for the user's requirements. However, to make the portable devices more compact and more easily carried, they may not be equipped with the function of connecting to Internet or have the limited connection function to Internet. For example, the linking speed and the data transmission capability of the portable device are worse than those of the host 10.

As mentioned above, if the user wants to download data from Internet to the portable device and to off-line browse the data with the portable device, he or she usually connects to Internet through other hosts to search required data. For instance, as shown in FIG. 2, the portable device 40 connects to the host 10 and then links to Internet 30 via the host 10. In this case, the user 20 can operate the portable device 40 or the host 10 to input the keyword(s) for searching the required data 31. Then, the searched data 31 are transmitted to the portable device 40 through the host 10. Finally, the user can carry the portable device 40 and browse the data 31 at the off-line state.

In the previously mentioned architecture, the user 20 can only off-line browse the data 31 stored in the portable device 40, but, however, the potable device 40 cannot provide the intellectual data management and data searching, which may not satisfy the modern users.

It is therefore an important subject of the invention to provide the network information browsing system and method, which can intellectually manage data and search data.

### SUMMARY OF THE INVENTION

In view of the foregoing, the invention is to provide a network information browsing system and a network information browsing method that can intellectually manage data and search data

To achieve the above, a network information browsing system of the invention includes a host and a portable device, which includes a transmitting module, a database, an interface module, a selecting module and a re-searching module. In the invention, the host retrieves a plurality of data through a network. The transmitting module connects to the host for receiving the data, and the database stores the data. The interface module displays at least one of the data, and the selecting module generates at least one keyword based on the data displayed by the interface module. The re-searching module automatically performs a data searching action according to the keyword.

In addition, to achieve the above, a portable device of the invention, which is cooperated with a host, includes a transmitting module, a database, an interface module, a selecting module and a re-searching module. In the invention, the transmitting module connects to the host for receiving a plurality of data. The database stores the data. The interface module displays at least one of the data. The selecting module generates at least one keyword based on the data displayed by the interface module. The re-searching module automatically performs a data searching action according to the keyword.

Moreover, the invention also discloses a network information browsing method, which includes the following steps of: retrieving a plurality of data by a host through a network, receiving the data from the host by a portable device, displaying at least one of the data by the portable device, generating at least one keyword based on the displayed data, and automatically performing a data searching action according to the keyword.

As mentioned above, since the network information browsing system and method of the invention can utilize the portable device to generate the keyword again according to the displayed data. Besides, the re-searching module of the invention can automatically performing the data searching action according to the keyword, so that the intellectual data management and data searching can be carried out based on the browsing behaviors of the user. Thus, the user can off-line browse the data efficiently, and the portable device can automatically search the data matching the demands of the user for satisfying the modern users.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing the conventional network browsing system;

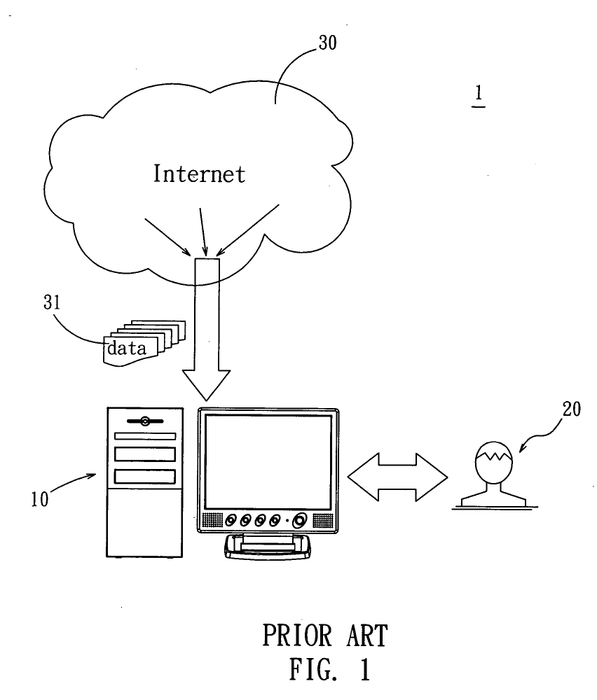

FIG. 2 is a schematic illustration showing the conventional network browsing system for off-line browsing;

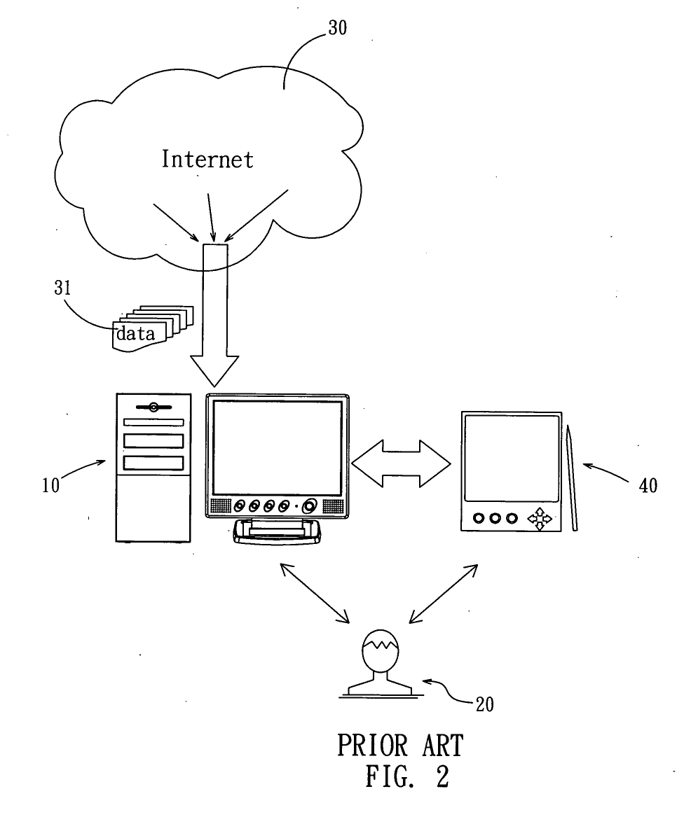

FIG. 3 is a schematic illustration showing a network information browsing system according to a preferred embodiment of the invention; and

FIG. 4 is a flow chart showing a network information browsing method according to a preferred embodiment of the invention.

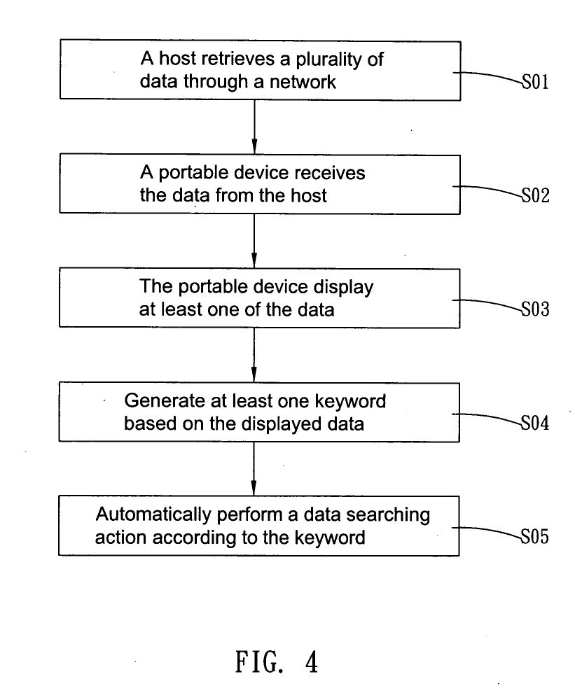

### DETAILED DESCRIPTION OF THE INVENTION

The present invention will be apparent from the following detailed description, which proceeds with reference to the accompanying drawings, wherein the same references relate to the same elements.

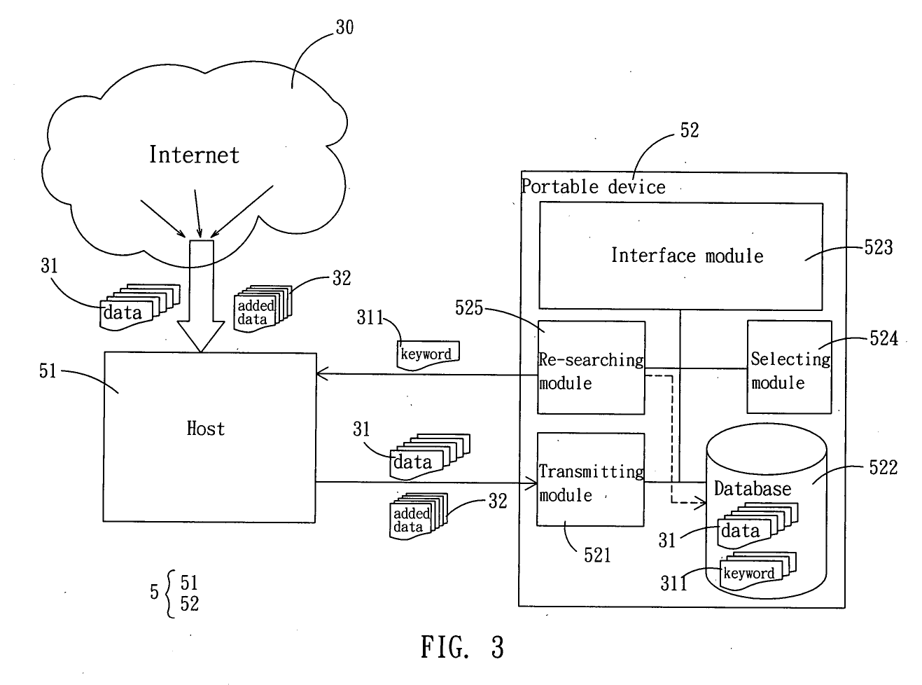

With reference to FIG. 3, a network information browsing system 5 according to a preferred embodiment of the invention includes a host 51 and a portable device 52.

As shown in FIG. 3, the host 51 retrieves a plurality of data 31 through Internet 30. In this embodiment, the user 20 firstly inputs a keyword to the host 51 or the portable device 52, and then the host 51 can search the data 31 matching the keyword from the Internet 30 with utilizing the in-build searching engine or the public searching engine such as Google. After that, the searched data 31 are downloaded to the host 51.

In the current embodiment, the portable device 52 includes a transmitting module 521, a database 522, an interface module 523, a selecting module 524, and a re-searching module 525. The transmitting module 521 connects to the host 51 for receiving the downloaded data 31, which are then stored in the database 522. Therefore, the user 20 can browse the data 31 with the portable device 52 at the off-line state. For example, the user 20 may disconnect the connection between the host 51 and the portable device 52, and then carry the portable device 52. When the user 20 needs to browse or has time to browse the data 31, he or she can then operate the portable device 52 to display at least one of the data 31 through the interface module 523.

When the user 20 browses one data 31 and is interested in one paragraph of the article, he or she can utilize the selecting module 524 to generate at least one keyword 311 based on the data 31 displayed by the interface module 523. In more detailed, the selecting module 524 can select at least one marked content in the data 31 displayed by the interface module 523 and then generates the keyword 311 based on the marked content. Alternatively, the selecting module 524 may generate the keyword 311 based on a topic of the data 31 displayed by the interface module 523. Besides, the selecting module 524 may also adopt any kind of intellectual learning depending on the heavier of the user 20 to generalize the proper keyword 311 from the browsed data 31. Herein, the generated keyword 311 is also stored in the database 522.

After the selecting module 524 generates the keyword 311, the re-searching module 525 automatically performs a data searching action according to the keyword 311. In the present embodiment, the data searching action performed by the re-searching module 525 is to search the database 522 according to the keyword 311. Thus, the re-searching module 525 can then retrieve at least another one of the plural data 31 from the database 522 according to the keyword 311. In other words, when the user 20 browses one data 31, the selecting module 524 firstly intellectually generates the keyword 311 according to the behavior of the user 20, and then the re-searching module 525 searches the plural data 31 stored in the database 522 according to the keyword 311. Accordingly, the other data 31 related to the keyword 311 interesting the user 20 can be retrieved.

In addition, when the user 20 connects the portable device 52 to the host 51 again, the re-searching module 525 can automatically performs the data searching action through the host 51 according to the keyword 311, so that a plurality of added data 32 can be retrieved from the Internet 30 through the network. Then, the transmitting module 521 further receives the added data 32 from the host 51. In this manner, the user 20 is unnecessary to do additional settings or searching actions, and the portable device 52 can automatically search the added data 32 related to the keyword 311 interesting the user 20 from the Internet 30. Therefore, the database 52 of the portable device 52 may grow with the added data 32, and the stored data, including the data 31 and the added data 32, are much closer to the interest and requirement of the user 20.

Furthermore, the invention also discloses a network information browsing method, which is applied with the previously mentioned network information browsing system 5. With reference to FIG. 5, the network information browsing method according to a preferred embodiment of the invention includes the following steps.

First, in step S01, a host retrieves a plurality of data through a network. Next, in step S02, a portable device receives the data from the host. To be noted, the portable device c an connect to the host in advance and the user can then input the keyword through the host or the portable device for searching the data. Alternatively, the user can use the host to search the data firstly and then connect the host to the portable device for downloading the data from the host to the portable device.

After that, the step S03 is to display at least one of the data by the portable device. Of course, the portable device can display a single data or several data.

Then, the step S04 is to generate at least one keyword based on the displayed data. In the current embodiment, the step S04 may be firstly to select at least one marked content in the displayed data, and then to generate the keyword based on the marked content. Alternatively, the step S04 may be to generate the keyword based on a topic of the displayed data.

Finally, the step S05 is to automatically perform a data searching action according to the keyword. In this embodiment, the step S05 may be to retrieve other one or more of the data from the database according to the keyword. Since the step S05 is to retrieve the data according to the generated keyword, the retrieved data may match the related subject that the user wants to browse. Accordingly the user is unnecessary to search the desired data by himself or herself, which can save the searching time of the user. In addition, the step S05 may be to transmit the keyword from the portable device to the host, and then to retrieve a plurality of added data by the host through the network. After that, the added data are transmitted from the host to the portable device. Thus, it is unnecessary for the user to spend time on searching the desired data, and the desired data, such as the added data, can be automatically retrieved. In the point of the user, the invention is very convenient.

In summary, since the network information browsing system and method of the invention can utilize the portable device to intellectually generate the keyword again according to the displayed data. Besides, the re-searching module of the invention can automatically performing the data searching action, including to search other related data from the database or to search added data via the host, according to the keyword. Therefore, the intellectual data management and data searching can be carried out based on the browsing behaviors of the user. Thus, the user can off-line browse the data efficiently, and the portable device can automatically search the data matching the demands of the user for satisfying the modern users.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A network information browsing system, comprising:
a host, which retrieves a plurality of data through a network; and
a portable device, which comprises:
a transmitting module connecting to the host for receiving the data,
a database storing the data,
an interface module displaying at least one of the data,
a selecting module generating at least one keyword based on the data displayed by the interface module, and
a re-searching module automatically performing a data searching action according to the keyword.

2. The system of claim 1, wherein the selecting module selects at least one marked content in the data displayed by the interface module and then generates the keyword based on the marked content.

3. The system of claim 1, wherein the selecting module generates the keyword based on a topic of the data displayed by the interface module.

4. The system of claim 1, wherein the database further stores the keyword.

5. The system of claim 1, wherein the re-searching module automatically performs the data searching action on the database according to the keyword, so that at least another one of the data is retrieved from the database according to the keyword.

6. The system of claim 1, wherein the re-searching module automatically performs the data searching action through the host according to the keyword, so that a plurality of added data are retrieved through the network.

7. The system of claim 6, wherein the transmitting module further receives the added data from the host.

8. A portable device, which is cooperated with a host, comprising:
a transmitting module, which connects to the host for receiving the data;
a database, which stores the data;
an interface module, which displays at least one of the data;
a selecting module, which generates at least one keyword based on the data displayed by the interface module; and
a re-searching module, which automatically performs a data searching action according to the keyword.

9. The device of claim 8, wherein the selecting module selects at least one marked content in the data displayed by the interface module and then generates the keyword based on the marked content.

10. The device of claim 8, wherein the selecting module generates the keyword based on a topic of the data displayed by the interface module.

11. The device of claim 8, wherein the database further stores the keyword.

12. The device of claim 8, wherein the re-searching module automatically performing the data searching action on the database according to the keyword, so that at least another one of the data is retrieved from the database according to the keyword.

13. The device of claim 8, wherein the re-searching module automatically performing the data searching action through the host according to the keyword, so that a plurality of added data are retrieved through a network.

14. The device of claim 13, wherein the transmitting module further receives the added data from the host.

15. A network information browsing method, comprising the steps of:
retrieving a plurality of data by a host through a network;
receiving the data from the host by a portable device;
displaying at least one of the data by the portable device;
generating at least one keyword based on the displayed data; and
automatically performing a data searching action according to the keyword.

16. The method of claim 15, wherein the step of generating the keyword based on the displayed data comprises:
selecting at least one marked content in the displayed data; and
generating the keyword based on the marked content.

17. The method of claim 15, wherein the step of generating the keyword based on the displayed data comprises:
generating the keyword based on a topic of the displayed data.

18. The method of claim 15, wherein the step of automatically performing the data searching action according to the keyword comprises:
retrieving at least another one of the data from the database according to the keyword.

19. The method of claim 15, wherein the step of automatically performing the data searching action according to the keyword comprises:
transmitting the keyword from the portable device to the host; and
retrieving a plurality of added data by the host through the network.

20. The method of claim 19, wherein the step of automatically performing the data searching action according to the keyword further comprises:
transmitting the added data from the host to the portable device.
